(19) United States
(12) Patent Application Publication
(10) Pub. No.: US 2009/0249696 A1
(43) Pub. Date: Oct. 8, 2009

(54) TOP LIFT OVERHEAD DOOR ASSEMBLY

(75) Inventors: Donald L. Metz, Kirkville, NY (US); Vincent E. Preuss, Weedsport, NY (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: DL MANUFACTURING, North Syracuse, NY (US)

(21) Appl. No.: 12/099,178

(22) Filed: Apr. 8, 2008

(51) Int. Cl. E05D 15/38

(52) U.S. Cl. 49/199

(57) ABSTRACT

An overhead door with rollers on its sides is provided with a pair of elevated, non-vertical tracks into which the rollers move as the door is moved to the open position. The door is opened by cables that extend from a pair of drums, to pulleys at the distal ends of the tracks, and then to the top corners of the door. Provision is made for transitioning curved portions of the tracks, and, in some cases, vertical portions below the curved portions, by a plurality of links provided between the cable ends and the door upper corners.

### TECHNICAL FIELD

This invention relates generally to overhead doors and, more particularly, to an overhead door which is raised to a non-vertical position by a cable connection at the top corners of the doors.

### BACKGROUND OF THE INVENTION

Overhead doors are installed to occlude openings in structures such as warehouses, factories, and other commercial establishments. Typically, such a door is comprised of a series of panels hinged together and moveable between a downward closed position to an upward open position. In the open position, the door may be disposed in a vertical, horizontal or a so called tilt-back or oblique position.

In the simplest form, wherein the open door is stored in a vertical position above the opening, it is an easy matter to locate the cable drums directly above the vertically aligned tracks such the cables connected to the door remain aligned with the tracks as the door is raised. Thus, it has been possible to connect the cable to the top corners of the door rather than to the bottom corners thereof. A significant disadvantage to the vertical storage arrangement is that the height of the building must be substantially increased to accommodate the raised height of the door. Thus, a more common approach is to support the open door in either an oblique or horizontal position.

Considering first the oblique arrangement, wherein the door, rather than being raised vertically upward, is rolled around an angled track portion and then along a plane that is at an oblique angle with the vertical wall. Since the drum and its connecting cable has traditionally been vertically orientated, the cable has not been able to be secured to the top of the door since it would tend to diverge farther from the vertical plane as it moves to the open position, thereby causing a binding condition such that the door would not be able to be fully opened. For this reason, such an oblique storage arrangement has had the cable attached to the bottom panels of the door such that the cable can remain in the vertical position as the door is raised to an open, non-vertical position.

In the case of a high lift door, wherein the door is stored in a horizontal open position, the binding condition becomes even worse since the door is moving in a direction normal to that of the powering cable. Thus, it has been even more imperative that the cable be connected to the bottom panels of the door such that, as the cable is raised vertically, the upper portion of the door may be diverted to the horizontal position.

The applicants have recognized that various problems occur with such a bottom lift door. This is particularly true where the doors are of a “knock-out” design wherein provision is made for the doors to be temporarily disengaged from their tracks when in the downward position in order to prevent damage to the doors. Such a design is described in U.S. Pat. No. 6,988,528, granted on Jan. 24, 2006 and issued to the assignee of the present invention. It has been recognized that when such a disengagement occurs, since an upward force is being exerted on the lower panels, there is a tendency for the panels to buckle or roll up, a condition which can be both inconvenient and possibly pose a safety hazard. Another inconvenience of such a bottom connected disengageable door is that, in order for the connecting cable not to interfere with the brush structure at the top of the door, it is necessary to connect the cables at positions outward of the brush structure.

A further problem of such a bottom connected door, and one that is recognized as a problem for doors that are not even of the disengageable type, is that it results in a pushing up against the adjacent sections causing a buckling and crimping of those sections rather than a smooth upward movement thereof. That is, the upward moving force is a compression force acting against the gravitational force of each of the sections.

### DISCLOSURE OF THE INVENTION

In accordance with one aspect of the invention, a pair of pulleys are mounted on the distal ends of the non-vertically oriented tracks for storing an overhead door in an open position. The cables from the drums are then extended over the respective pulleys and extend along the respective tracks to connect to their respective top corners of the door. Such an arrangement allows for the smooth lifting of the top of a door along the plane of the tracks.

By another aspect of the invention, in order to accommodate the curved portion of the track, as well as the vertical raising of the top portion of the door to this curved portion of the track in some cases, the length of the door is effectively increased by the addition of a plurality of links secured to the upper corners of the door, with the upper links then being secured to the cable extending to the pulley. In this manner, the powering force exerted at the pulley acts along the track and allows the links to move upward and around the curved portion of the track in a smooth and non binding manner.

### BRIEF DESCRIPTION OF THE DRAWINGS

FIG. 1 is a perspective view of a tilt-back door with the present invention incorporated therein.

FIG. 2 is an enlarged partial perspective view thereof.

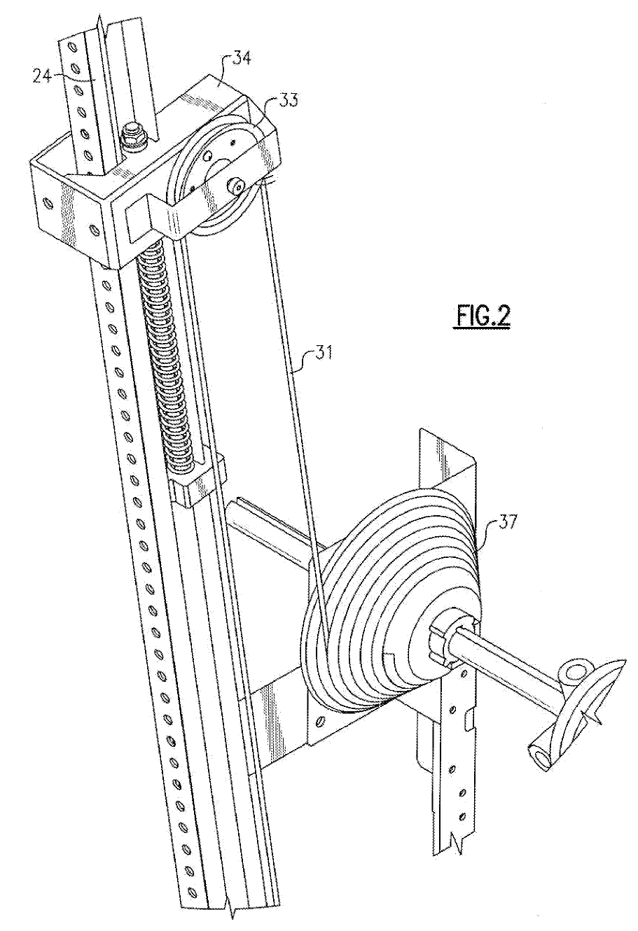

FIG. 3 is an enlarged partial sectional view thereof showing one portion thereof.

FIG. 4 is a perspective view of a horizontally stored door with the present incorporated therein.

FIG. 5 is an enlarged partial view of a particular portion thereof.

FIG. 6 is an enlarged partial view of another particular portion thereof.

FIGS. 7 and 8 are perspective views of a high lift door with the present invention incorporated therein.

FIG. 7A is an enlarged partial view of a particular portion of the FIG. 7 embodiment.

FIG. 8A is an enlarged partial perspective view of a particular portion of the FIG. 8 embodiment.

### DETAILED DESCRIPTION OF THE INVENTION

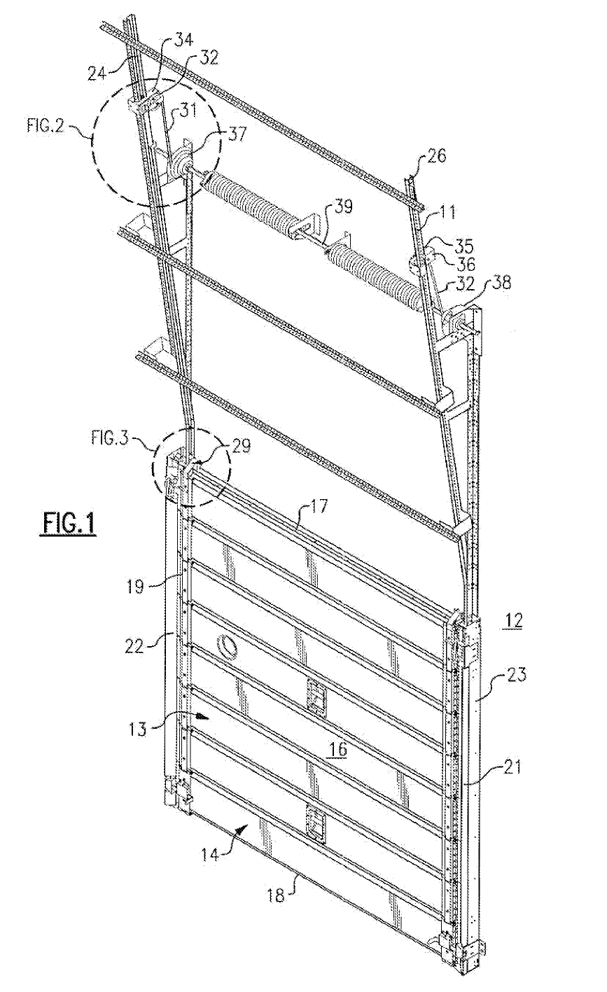

Referring now to FIG. 1, there is shown a so called tilt-back door installation wherein the framework 11 is oriented at an oblique angle with the vertical wall 12 for storage of the door in the plane of the framework 11 when in the open position. As shown, the overhead door 13 is mounted in a vertically oriented, closed position to close an opening 14 in the building wall 12. The door 13 is comprised of a plurality of panels 16 which are integrally connected at their transversely extending edges such that the door 13 is flexible to permit its movement to an open and stored position. The door 13 has upper and lower edges 17 and 18 and side edges 19 and 21.

Mounted to the wall 12, on either side of the door 13 are vertical support members 22 and 23. The door 13 is supportably mounted within the vertical support members 22 and 23 in such a manner which permits the door 13 to be temporarily disengaged from its mounting position when impacted by a substantial force as shown and described in U.S. Pat. No. 6,988,528, having common ownership herewith and incorporated herein by reference. Thus, when the door is in the closed position as shown, the brush structures attached to the side edges 19 and 21 are slideable disposed in the vertical support members 22 and 23, respectively, but are adapted to be “knocked out” of those installed positions if sufficient force is exerted, either inwardly or outwardly against the door 13.

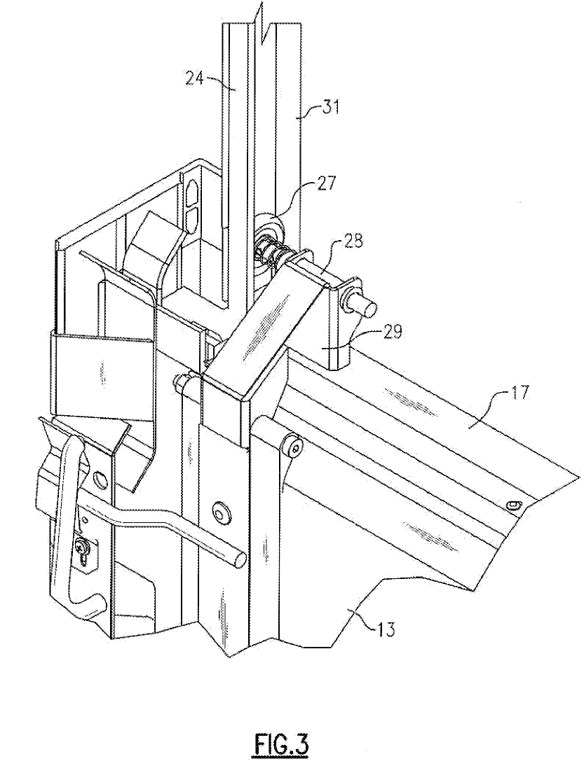

Considering now the movement and support of the door 13 when it is moved to the open position, it will be seen in FIGS. 1 and 3 that the frame 11 includes the laterally spaced tracks 24 and 26, which are U-shaped structures that form tracks facing inwardly for rollably receiving a plurality of rollers 27 (see FIG. 3) which are attached to the side edges 19 and 21 of the door. In FIG. 3, there is shown a single roller 27 attached to a shaft 28 and bracket 29 to the upper edge 17 of the door in such a manner that the shaft 28 and its roller 27 extends transversely into the track 24. Although not shown, it should be understood that the door 13 includes a plurality of such rollers and may have one or more rollers on each side of each of the panels. Thus, as the door 13 is raised, the rollers 27 progressively enter the tracks 24 and 26, respectively, with the tracks 24 and 26 then acting to support the door in its raised and open position.

As will be seen in FIGS. 1 and 3, rather than being connected to the door 13 near its lower edge 18, the cables 31 and 32 are connected near the upper edge 17. In particular, the cable 31 is connected to the shaft 28, and the cable 32 is connected at the other top corner of the door 13.

Also, unlike the prior art arrangements, the tracks 24 and 26 have attached near their distal ends, the respective pulleys 33 and 35 by way of the respective brackets 34 and 36. The cable 31 therefore extends from the drum 37 upwardly to the pulley 33 and then downwardly to the shaft 28. Similarly, the cable 32 extends from the drum 38 upwardly to the pulley 35 and downwardly to the other top corner of the door as shown in FIG. 1.

In operation, when it is desired to open the door, the drum shaft 39 is caused to rotate by some means such as a drive motor, a counterweight, or torsionial springs, with the cables 31 and 32 then being wound up on the respective drums 37 and 38. This causes the respective cables 31 and 32 to lift the door 13 from its upper corners. The rollers 27 are then allowed to feed into the respective tracks 24 and 26 in the manner as described hereinbefore. It will thus be seen, that as the door is raised, the cables 31 and 32 connected to the top corners of the door will remain substantially in alignment with their respective tracks 24 and 26 during the entire period of raising or closing the door. Such an arrangement therefore allows for the attachment of the cables to the upper corners of the door and therefore overcomes the problems associated with the connections to the lower portions of the door.

It will be seen in FIG. 1 that with such a tilt-back arrangement, there is a slight bend of the tracks 24 and 26 near their proximal ends such that during the initial vertical movement of the upper portion of the door, the cable 31 and 32 will not be perfectly aligned with the respective tracks. However, considering the lengths of the tracks 24 and 26, and their relatively small bends thereof, the cable and tracks will be closely enough aligned that relatively smooth movement of the door can be made to occur. Of course, when the cable attachment has risen vertically to the point of the bend, then the two will be aligned for the remainder of the upward movement.

For horizontally stored doors, the bend which the door must transverse as it is raised is not negligible as described hereinabove but is rather a 90° bend which would not allow for a smooth transition between the closed and open positions as discussed hereinabove unless other provisions are made. Accordingly, a horizontally stored door will now be described with the present invention being adapted to accommodate the greater curvature in the track.

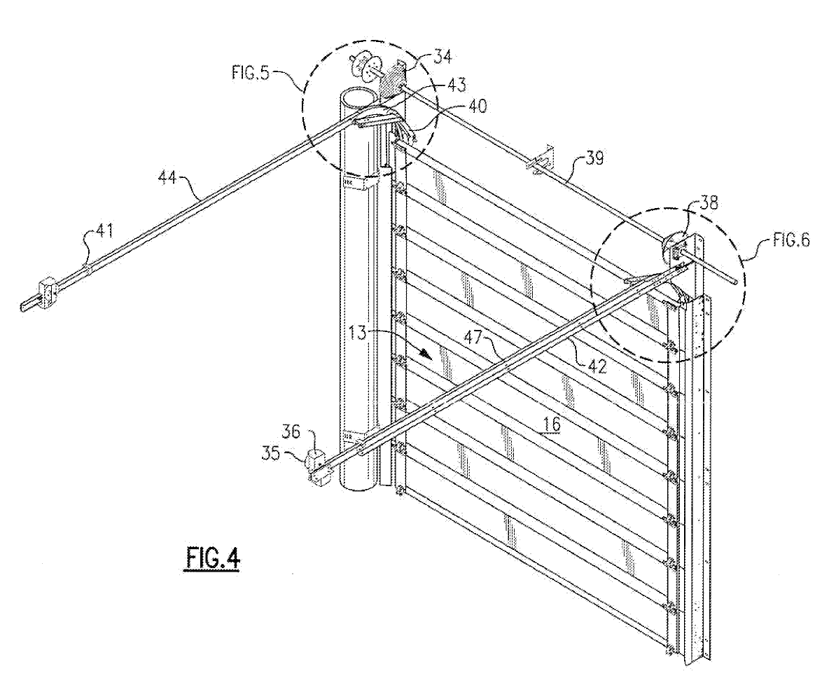

As will be seen in FIG. 4, the door 13 when in the closed position is substantially identical to the door as described hereinabove. Thus, drums 37 and 38 are provided and are turned by way of the shaft 39 to move the respective cables to progressively greater diameters in order to raise the door. However, it will be seen that the tracks 41 and 42 are substantially horizontally disposed and include curved portions 43 and 44 while making the transitions between the vertical and the horizontal positions. Again, the pulleys 33 and 35 are attached near the distal ends of the tracks 41 and 42 as shown. Again, the respective cables 46 and 47 extend from their drums 37 and 38, around the pulleys 33 and 35, and then back along the respective tracks in substantial alignment therewith. However, in this case, it is not feasible to attach the cable directly to the upper corners of the door 13 since a horizontal force exerted by the cables would not tend to raise the door vertically but would rather tend to pull the door horizontally and bind up. It is therefore necessary to provide a linkage between the ends of the cables and the upper corners of the door 13 in order to obtain an upward component of force to act on the door. Thus, a link 48 is provided with its one end connected to the end shaft 28 and with its other end flexibly attached to a second link 49 by pin 51. The second link 49 has its other end attached to the cable 46 as shown. Similarly, at the other corner of the door, first and second links 52 and 53 are provided to interconnect the door to the cable 47.

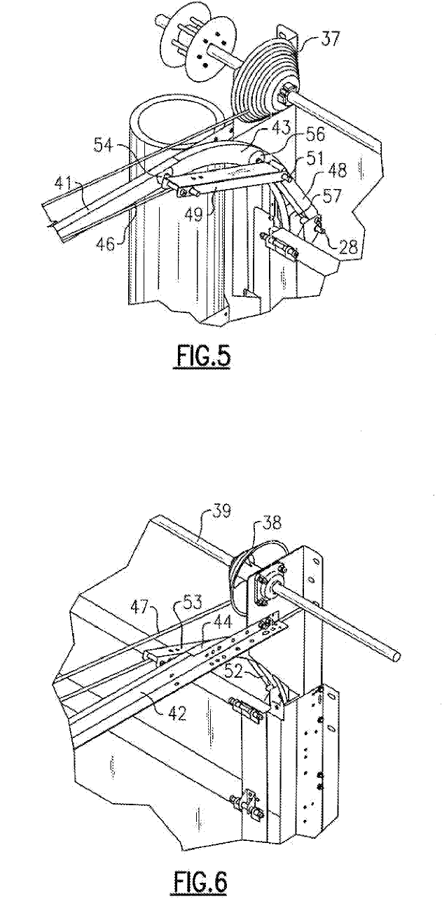

As will be seen in FIG. 5, rollers 54, 56 and 57 are provided at the ends of the links 48 and 49 and at the intermediate pin 51. Similar rollers are provided in the links 52 and 53 on the other side.

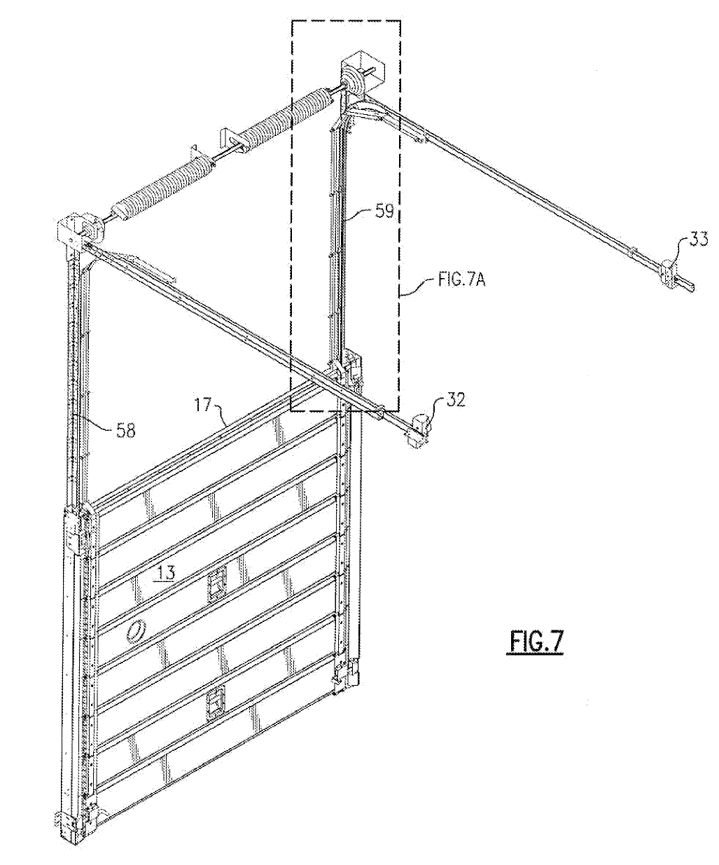

Considering now the effect of the linkages and their associated rollers, it will be seen in FIGS. 5 and 6 that with the door in the fully closed positions and the linkages in place, the cables can be pulled in the horizontal direction to thereby exert a horizontal force on the ends of the first and second links 49 and 53. At that point, a pin 51 will have a force exerted thereon at substantially a 45° angle to thereby move the roller 56 along the curved portion 43 of the track. The same force acting on the pin 51 at a 45° angle will pull the first link 48 in that 45° direction and exert that same directional force on the shaft 28. This force will cause the roller 57 to move along the curved portion 43 and commence to raise the door in the vertical direction. When the roller 57 has completed its movement through the curved portion 43, the links 48 and 59 will be aligned with the track 41, and the remaining movement of the upper portion of the door, including the shaft 28, will be in alignment with the track 41. Although shown with a pair of links 48 and 49, it should be understood that a greater number of links may also be used in this manner.

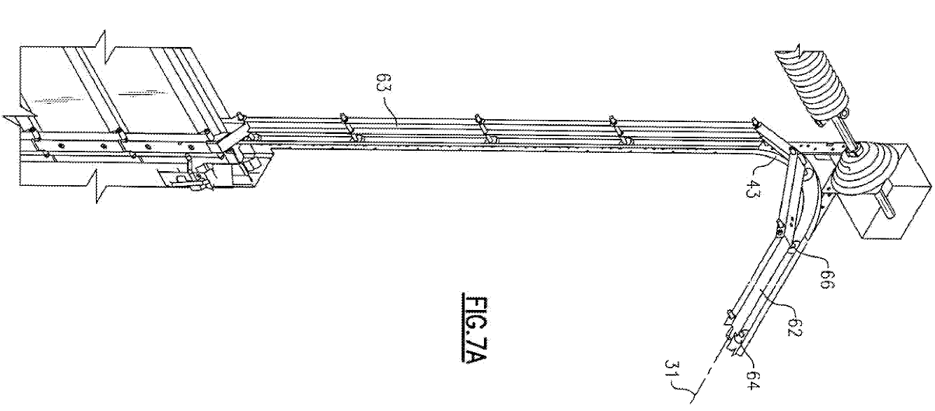

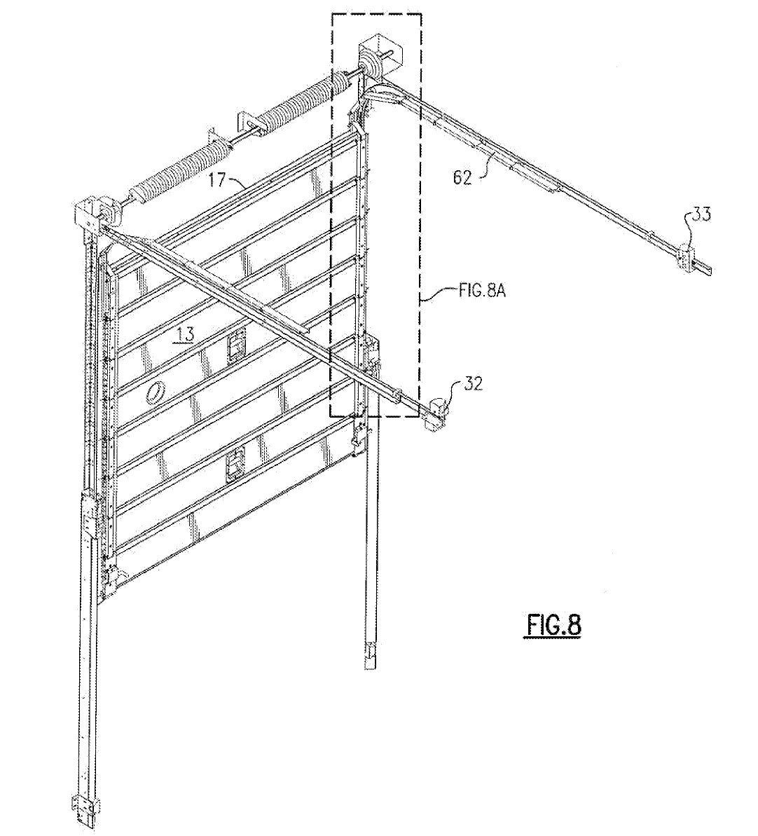

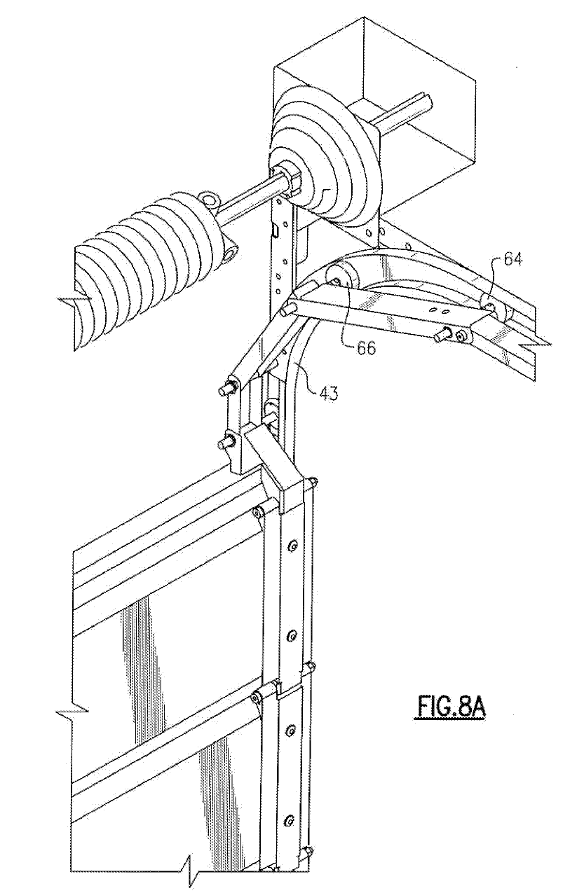

Referring now to FIGS. 7 and 8, there is shown a high lift door wherein, rather than transitioning directly from the vertical closed position to the horizontal open position, the door is raised in the vertical plane for some distance before it transitions to the horizontal plane. Thus, in FIG. 7 wherein the door 13 is shown in the closed position, the tracks 58 and 59 extend vertically upwardly from the upper edge 17 of the door 13 before transitioning by way of curved portions that then connect to the horizontal portions on which the pulleys 32 and 33 are attached in the same manner as described hereinabove. Thus, in addition to the links that were added in the FIG. 4 embodiment to interconnect the cables to the door upper portion to thereby span the curve portions 43 as shown in FIG. 4, it is also necessary to span the distance of vertical rise of the door from its closed position as shown in FIG. 7 to its position as shown in FIG. 8 wherein the upper edge has risen to the point of the curved portion 43. Thus, as will be more clearly seen in FIGS. 7A and 7B a number of links 61 are provided on each side of the door with the top link 62 being connected to the cable 31 and the bottom link 63 being connected to the door upper corner. A roller is provided at the top end of each of the links as shown at 64 and 66. These rollers, and their engagement with their respective tracks, allow the individual links to be moved sequentially first in the upward direction, then along the curved portions 43 and into the horizontally disposed portions of the tracks.

While the present invention has been particularly shown and described with reference to a preferred mode and alternative embodiments as illustrated in the drawings, it will be understood by one skilled in the art that various changes in detail may be effected therein without departing from the spirit and scope of the invention as defined by the claims.

We claim:

1. An overhead door assembly, comprising:
a plurality of door panels pivotally interconnected along respective transverse extending edges of the panels, at least some of said panels having rollers attached to and extending from either side thereof;
a support structure for supporting said plurality of door panels when in a raised position, said support structure comprising a pair of laterally spaced tracks that are aligned in a plane which is other than substantially vertical as they extend from their respective proximal to distal ends, said tracks being adapted to receive said rollers therein;
a pair of pulleys rotatingly secured to the distal ends of the respective tracks; and
a pair of cables attached to the respective top corners of an upper door panel, with each cable extending over its respective pulley and being operatively connected to a drum, such that when the drum rotates to pull the cable, that portion of the cable attached to the door remains substantially aligned with its respective track.

2. An overhead door assembly as set forth in claim 1 wherein said pair of cables are attached to the upper door panel by way of brackets extending from the upper edge of the door.

3. An overhead door assembly as set forth in claim 2 wherein said bracket includes a shaft and an attached roller, with the roller being rollably disposed within its track.

4. An overhead door assembly as set forth in claim 1 wherein said laterally spaced tracks include an angled or curved portion near their proximal ends.

5. An overhead door assembly as set forth in claim 1 wherein said laterally spaced tracks are substantially horizontally disposed.

6. An overhead door assembly as set forth in claim 5 wherein said pair of cables are attached to the upper door panel by way of a plurality of links.

7. An overhead door assembly as set forth in claim 6 wherein said links include shafts with rollers attached thereto, and with the rollers being rollably disposed within the laterally spaced tracks.

8. An overhead door assembly as set forth in claim 7 wherein said links include shafts and rollers at the ends which connect to the cable and to the door, respectively.

9. An overhead door assembly as set forth in claim 7 wherein said links include a pin and roller at the intersection of adjacent links.

10. An overhead door assembly as set forth in claim 6 wherein the combined length of said plurality of links is sufficient to span from one end of said curved portion to the other end thereof.

11. An overhead door assembly as set forth in claim 10 wherein said overhead door is of the high lift type wherein the door is first raised vertically for a distance before transitioning to a horizontal position, and further where the combined length of said plurality of links is further sufficient to span the vertically raised distance.

12. An overhead door comprising:
a door for closing an opening in a wall, said door having a plurality of panels and upper and lower edges;
a plurality of rollers attached to sides of the door;
a pair of transversely spaced tracks disposed in a non-vertical plane at an elevated position with respect to the opening, said tracks extending from their proximal ends nearer to said door upper edge to their distal ends and being adapted to receive said rollers therein as said door is raised from its closed position;
a pair of pulleys attached to the respective said distal ends of said tracks;
a pair of drums disposed above the door and adapted to be rotated; and
a pair of cables, one attached to each of the upper corners of said door and extending to one of said pulleys and then to one of said drums.

13. An overhead door assembly as set forth in claim 12 wherein said pair of cables are attached to the upper door panel by way of brackets extending from the upper edge of the door.

14. An overhead door assembly as set forth in claim 13 wherein said bracket includes a shaft and an attached roller, with the roller being rollably disposed within its track.

15. An overhead door assembly as set forth in claim 12 wherein said laterally spaced tracks include an angled or curved portion nearer to their proximal ends.

16. An overhead door assembly as set forth in claim 12 wherein said laterally spaced tracks are substantially horizontally disposed.

17. An overhead door assembly as set forth in claim 16 wherein said pair of cables are attached to the upper door panel by way of a plurality of links.

18. An overhead door assembly as set forth in claim 17 wherein said links include shafts with rollers attached thereto, and with the rollers being rollably disposed within the laterally spaced tracks.

19. An overhead door assembly as set forth in claim 18 wherein said links include shafts and rollers at the ends which connect to the cable and to the door, respectively.

20. An overhead door assembly as set forth in claim 18 wherein said links include a pin and roller at the intersection of adjacent links.

21. An overhead door assembly as set forth in claim 17 wherein the combined length of said plurality of links is sufficient to span from one end of said curved portion to the other end thereof.

22. An overhead door assembly as set forth in claim 21 wherein said overhead door is of the high lift type wherein the door is first raised vertically for a distance before transitioning to a horizontal position, and further where the combined length of said plurality of links is further sufficient to span the vertically raised distance.
